(19) United States
(12) Patent Application Publication
(10) Pub. No.: US 2009/0134126 A1
(43) Pub. Date: May 28, 2009

(54) Electric-discharge machining apparatus and electric-discharge machining method

(75) Inventors: Hidetaka Katougi, Tokyo (JP); Tatsushi Sato, Tokyo (JP); Shingo Chida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, TOKYO (JP)

(21) Appl. No.: 10/585,861

(22) PCT Filed: Jan. 29, 2004
(86) PCT No.: PCT/JP04/00835

§ 371 Date: Jun. 10, 2008

(51) Int. Cl. B23H 1/00

(52) U.S. Cl. 219/69.13; 219/69.17

(57) ABSTRACT

In an electric-discharge machining apparatus for controlling a machining axis so that an average voltage Vg during a predetermined sampling time Ts agrees with a servo standard voltage SV, the apparatus includes: an electric power supplier 9 for supplying electric power between electrodes of a tool electrode 8 and a target W to be machined; an electric-discharge detector 13 for detecting the waveform of electric discharge generating between the electrodes based on the electric power supplied by the electric power supplier 9; an electric-discharge generation counter 14 for counting in response to the waveform an electric-discharge generation count Nd during the predetermined sampling time Ts; a calculator 12 for calculating an estimation average voltage Vgs between the electrodes based on the electric-discharge generation count Nd; and an electrode-position controller 10 for controlling the machining axis so that the estimation average voltage Vgs calculated by the calculator 12 agrees with the servo standard voltage SV during the sampling time Ts.

### TECHNICAL FIELD

The present invention relates to an electric-discharge machining apparatus and an electric-discharge machining method, especially relates to a technology for recognizing an electric-discharge machining state and for controlling machining-axis feeding based on a recognition result.

### BACKGROUND ART

In electric-discharge machining apparatuses, electric discharge is generated between a tool electrode and a target to be processed that are provided in a machining liquid, and thereby the target is melted and removed in the machining liquid. In electric-discharge machining operations, because machining waste produced with the target being melted and removed generates between the tool electrode and the target (hereinafter referred to as “the machining gap”) where the electric discharge occurs, if this machining waste is not removed from the machining gap by any means, a normal state with respect to insulation recovery of the machining gap or to electric-discharge repeat becomes impossible to be maintained. Accordingly, it is well known that harmful influence such as decrease of the machining efficiency or deterioration of the machined-face state occurs.

In the electric-discharge machining apparatuses, in order to remove the machining waste and maintain the machining gap, an electric discharge voltage is detected, and thereby the machining axis is controlled in response to varying of the electric discharge voltage at every moment. For example, in a system disclosed in Japanese Patent Publication 13,195/1969, an average voltage (Vg) within a specified sampling time is taken as an electric discharge state, and compared with the servo standard voltage (SV) as a predetermined target average voltage; thereby, by controlling the machining-axis feeding, that is, by performing the servo control in the electric-discharge machining apparatus, electric-discharge stability during the machining operation is maintained. Specifically, a detection line is provided in the machining gap formed by the tool electrode and the target, a voltage across the machining gap at every moment is obtained by a detector, the discharge voltage at that every moment is averaged and smoothed through a filter circuit, the extracted voltage within a specified sampling time is taken as the average voltage (Vg), and the average voltage (Vg) is compared with the predetermined serve standard voltage (SV) in an axis controller of the apparatus; then, from a result of the comparison, when the average voltage detected is lower than an average voltage to be a target, the machining axis is set to be fed to the opposite direction of the machining direction, meanwhile when the voltage detected is higher than that, the machining axis is set to be fed to the machining direction.

In the method in which a state between the electrodes is detected, in order to control the machining axis, from voltage varying of the machining gap through the filter, because the sampling time and the time constant of the filter circuit are in a close relationship, when the time constant is set to an enough lower value than the sampling time, the circuit becomes easy to be affected by environmental disturbance, meanwhile when the time constant of the filter circuit is set to two or three times the sampling time, apparent difference from the target value generate caused by the effect of the charge-discharge characteristics of the configured filter (as referred to FIG. 8); therefore, it is a very difficult problem to design the filter, in addition to the problem of the intrinsic vibration characteristics of the machine. Moreover, in order to detect the voltage, a case in which a detection line is needed, or, alternatively, a case in which an exclusive detection line is not needed, but a supplying line from the electric source is substitutively used as the detection line is cited. However, in either of the cases, when the line length is lengthened, the L-component of the electrical circuit increases, and thus the voltage component detected from the state of the machining gap becomes a voltage through the L-component; therefore, a problem occurs in which the apparent voltage differs from that in the actual machining state.

An electric-discharge machining apparatus providing with a means for, using a clock pulse, counting an unloading time (Td), a pulse width (Ton), and a rest time (Toff) has been disclosed in Japanese Laid-Open Patent Publication 262,435/1994. In this system, due to the filter circuit for detecting the electric discharge being prevented, the above problem seems to have been solved. However, because the target to be controlled is the servo standard voltage (SV) itself, by varying the servo standard voltage (SV) in response to the machining state, improvement can be achieved in terms of the stability; however, the machining operation is resultantly performed under a state in which the servo standard voltage is relatively high, that is, the machining efficiency is decreased, and consequently a problem occurs that the machining speed remarkably decreases.

A system is disclosed in Japanese Laid-Open Patent Publication 246,518/1995, in which an electric-discharge frequency and a short-circuit count are counted, and then, using the result and the unloading time (Td) that has been separately determined, an electric-discharge gap length is estimated and controlled. However, in this system, the rest time (Toff) and the unloading time (Td) are too long in response to the pulse width (Ton), and the electric-discharge energy targets only to a little finish machining operation; therefore, if this technology is applied to conventional machining, the unloading time is needed to be lengthened, and therefore, as a result, a problem remains that the machining rate decreases.

A control means is disclosed in Japanese Laid-Open Patent Publication 170,645/1994, in which an electric-discharge frequency is counted similarly to the above, dispersion of the electric-discharge frequency and determination whether the electric discharge is appropriate or not are compensated by the Fuzzy inference, and the membership function related to the state variation is prepared so that a suitable control is performed. In this system, it is also discussed how to prevent the case in which the exceptional unsteadiness as the problem disclosed in Japanese Laid-Open Patent Publication 246,518/1995 occurs. However, when the membership function is defined, a lot of know-how is needed for the design itself, thereby, an affection of the membership function itself strongly appears in the machining stability and the machining result.

[Patent Document 1] Japanese Patent Publication 13,195/1969.

[Patent Document 2] Japanese Laid-Open Patent Publication 262,435/1994.

[Patent Document 3] Japanese Laid-Open Patent Publication 246,518/1995.

[Patent Document 4] Japanese Laid-Open Patent Publication 170,645/1994.

Here, the conventional problem is that the electric-discharge state at the discharge gap cannot be exactly detected; therefore, in a case in which either the filter circuit is used, or the electric-discharge frequency is detected by the counter and taken, if the electric-discharge state between the electrodes is exactly detected, each fundamental control operation itself in the servo control scarcely differs from the other.

### DISCLOSURE OF THE INVENTION

The present invention is made to resolve problems of the above described prior art. A prime objective of the present invention is, even if an apparatus having relatively simple configuration is used, to correctly detect a state of a machining gap that is configured of a tool electrode and a target to be machined, to reflect the state to electric discharge, and to control machining-axis feeding in response to varying for each moment, that is, to perform a servo control.

In order to achieve this objective, an electric-discharge machining apparatus according to a first aspect of the invention for controlling a machining axis so that a machining average voltage (Vg) during a predetermined sampling time agrees with a servo standard voltage (SV) includes: an electric power supplying means for supplying electric power between electrodes of a tool electrode and a target to be machined; an electric-discharge detection means for detecting the waveform of electric discharge generating between the electrodes based on the electric power supplied by the electric power supplying means; an electric-discharge generation counting means for counting in response to the waveform an electric-discharge generation count during the predetermined sampling time; a calculating means for calculating an estimation average voltage Vgs between the electrodes based on the electric-discharge generation count; and an electrode-position controlling means for controlling the machining axis so that the estimation average voltage Vgs calculated by the calculating means agrees with the servo standard voltage (SV) during the sampling time.

### BRIEF DESCRIPTION OF DRAWINGS

FIG. 1 is a configurational view illustrating a schematic configuration of an electric-discharge machining apparatus according to Embodiment 1;

FIG. 2 is a view for explaining detection of an electric-discharge generation count during any sampling time;

FIG. 3 is a view representing any electric-discharge phenomenon;

FIG. 4 is a view representing a relationship between average voltages across a machining gap and electric-discharge generation counts;

FIG. 5 is a view representing an actual relationship between average voltages across a machining gap and electric-discharge generation counts;

FIG. 6 is views representing actual relationships between average voltages across a machining gap and electric-discharge generation counts;

FIG. 7 is flowcharts illustrating control flows according to the present invention; and

FIG. 8 is a view representing a relationship between the waveform of a voltage across a machining gap and the waveform of a filter-circuit voltage.

### BEST MODE FOR CARRYING OUT THE INVENTION

### Embodiment 1

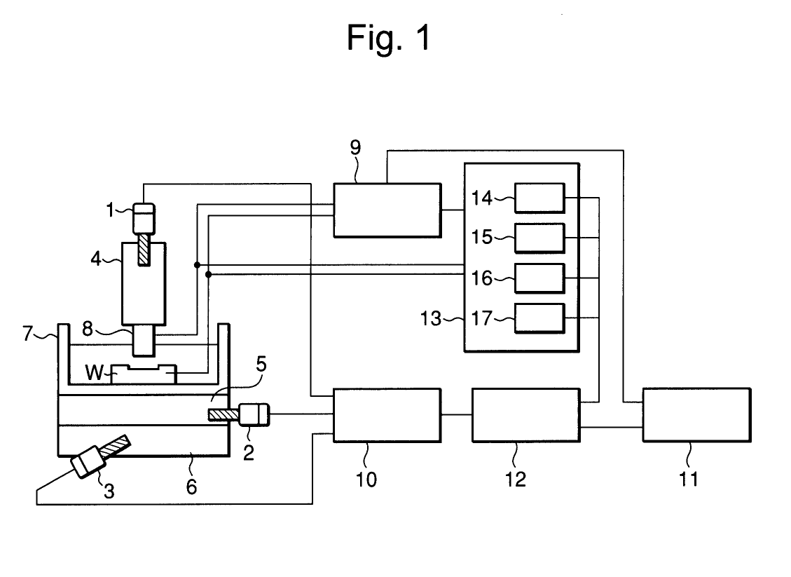

FIG. 1 is a view illustrating an electric-discharge machining apparatus according to an embodiment of the present invention. Here, in this embodiment, an example is explained in which work tables are movable along the X-axis and the Y-axis; however, an electric-discharge machining apparatus whose system includes a main-axis-side unit that is movable along the X-axis and the Y-axis may also be applied. An axis mechanism or a machine configuration itself mounted on the electric-discharge machining apparatus does not effect on the operation in the embodiment.

The electric-discharge machining apparatus includes a main-axis unit 4 driven by a motor 1 along the Z-axis orientation, a work table 5 driven by a motor 2 along the X-axis orientation, a main-axis work table 6 driven by a motor 3 along the Y-axis orientation, and a machining bath 7 mounted over the work tables 5 and 6, a tool electrode 8 is attached to the main-axis unit 4, and a machining liquid is poured into the machining bath 7 as well as a target W to be machined is placed therein. The tool electrode 8 and the target W placed in the machining liquid face each other having any machining gap, and by supplying between the tool electrode 8 and the target W electric power from an electric power source 9, electric discharge generates; thus, melting and removal of the target W is performed. In an electrode position controller 10, when a machining condition such as a machining program is set by a machining-condition setting unit 11, the motors 1, 2, and 3 are controlled following its program content; thus, a position control and a servo control of each axis are performed. Moreover, the electrode position controller 10 performs not only a jump control of the main-axis unit 4, but also an oscillation control for machining with a specified locus being given to the tool electrode 8 in response to the target W.

In the machining-condition setting unit 11, an electric-discharge current (IP), a pulse width (Ton), a rest time (Toff), an applied voltage (V0), a servo standard voltage (SV), jump-control setting (JUMP), oscillation-control setting (Orb), and a target machining position (Zref), etc., which are fundamental machining conditions set when electric discharge machining is operated, are registered and recorded using an input device. Other than the above parameters, for example, in order to discriminate the machining state, an electric discharge voltage (eg) when normal electric discharge occurs, an abnormal electric-discharge threshold voltage (Vng), a short-circuit threshold voltage (Vsh), a minimum unloading time (Tdo), and a rest time (Toffs) in which control for extending the rest time is performed when abnormal electric discharge occurs can also be set. Moreover, when a machining area (S) that is to be an electric-discharge machined portion of the target to be machined by the tool electrode 8 is already known, the machining area (S) can also be inputted. These information items each can be set and stored for each condition to be used; thereby, when the electric power source 9 calls out the predetermined fundamental machining condition, the items each is also called out, and read into each controller.

An electric-discharge detection circuit 13 records a total electric-discharge generation count (Nd) generated between the tool electrode 8 and the target W, and then the detection result is transferred into a main calculator 12. Here, after having been transferred into the calculator, each value detected by the electric-discharge detection circuit 13 is reset, and then the next sampling operation starts. Moreover, in the electric-discharge detection circuit 13, in a case in which the short-circuit threshold voltage (Vsh) is set in the machining-condition setting unit 11, based on the short-circuit threshold voltage (Vsh), its count (N1) is recorded in which the electric discharge whose voltage is lower than the threshold value is taken as short-circuited. Similarly, in a case in which the minimum unloading time (Tdo) is set, an electric-discharge operation during the unloading time being shorter than the minimum unloading time is recorded as a small unloading electric-discharge count (N2), and in a case in which the abnormal electric-discharge threshold voltage (Vng) is set, the electric discharge whose voltage is lower than the abnormal electric-discharge threshold voltage is recorded as an abnormal electric discharge count (N3), independently.

Here, the normal electric discharge is one having an unloading time (Td) that is longer than the minimum unloading time (Tdo), and is one whose electric-discharge voltage (eg) is higher than the abnormal electric-discharge threshold voltage (Vng).

Because the short circuit means a state in which the tool electrode 8 contacts with the target W, electric discharge in this state does not occur; however, due to the tool electrode 8 and the target being conducted together, short-circuit current flows. Because the short-circuit voltage of from nil to ten several V appears when short-circuited, a voltage that is lower than the short-circuit threshold voltage (Vsh) is recognized as the short-circuit one. Regarding the short circuit, although a case in which the tool electrode 8 and the target W are conducted through machining debris is also considered, the state is difficult to be recognized as a state in the machining gap; however, when the short circuit occurs, because the state goes to physical contact, deformation of the tool electrode occurs in an extreme case. Moreover, even in a case in which the contact is relatively light, a stain, etc. is caused thereby, and the quality of the machined face is deteriorated. Regarding the provision of the minimum unloading time (Tdo), the continuity of the short unloading times represents that electric discharge continuously occurs close to the electric-discharge generation, and in this case, a state appears that electric discharge generation is concentrated. The concentration of the electric discharge leads localized removal or machining, and machined-face swelling or shape-transcription deterioration is caused thereby.

The abnormal electric discharge belongs neither to short-circuited cases nor to short unloading-time cases, and is assumed not to be the normal electric discharge. As an example, a case is given in which, although the unloading time exists, the applied voltage (V0) during the unloading time decreases to a value lower than the predetermined value, and then leakage current flows. In this case, as obviously from the leakage current also flowing, due to the current flowing across the machining gap, it is considered that insulation recovery characteristics are lacking, and thus the next electric discharge becomes concentrated electric discharge or short-circuited one; consequently, because, when the insulation does not recover, the electric discharge goes to an arc, the quality of the machined face significantly deteriorates.

The machining operations progress with the short-circuited state, the concentrated state, and the abnormal electric-discharge state, etc. that are mixed into the normal electric-discharge state; however, it is not yet qualitatively and quantitatively examined what causes the states each occurs. In the present method, when a control for preventing the continuity of the problem is performed, based on the contents to be machined, and on the materials of the target to be machined, etc., by weighting each problem, and by extending the rest time caused by the problem, etc., each rest setting set for each phenomenon is used.

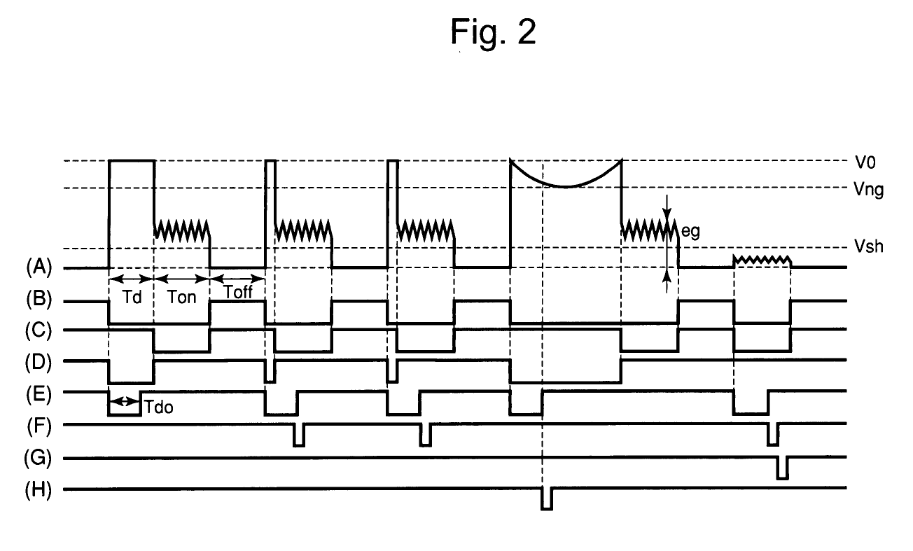

Next, a specific operation of the electric-discharge detection circuit 13 is explained using FIG. 2.

FIG. 2(A) represents by voltage and current an electric-discharging state of the machining gap between the tool electrode 8 and the target W during a sampling time (Ts).

FIG. 2(B) represents a voltage signal representing a time during voltage is applied across the electrodes, in which a time domain of the unloading-voltage time (Td) and the pulse width (Ton) is created. The inverse of the signal is to be the rest time (Toff).

FIG. 2(C) represents a signal of an electric-discharge time corresponding to the component time of the pulse width (Ton) when current flows, after insulation is broken down between the electrodes.

FIG. 2(D) represents the difference between FIG. 2(B) and FIG. 2(C), which represents the unloading-voltage time (Td).

FIG. 2(E) represents a comparison signal generated for a timing in which voltage is applied after generation of the rest time (Toff), in order to compare to the voltage-unloading time (Td) when the minimum unloading time (Tdo) is set in the machining-condition setting unit 11.

FIG. 2(F) represents a result obtained by comparing the voltage-unloading time (Td) with the minimum unloading time (Tdo). When the voltage-unloading time (Td) is lower than the minimum unloading time (Tdo), a signal is created as a one-shot signal.

FIG. 2(G) represents a one-shot signal generated in a case in which, when a short-circuit threshold voltage (Vsh) is set in the machining-condition setting unit 11, after the short-circuit threshold voltage (Vsh) and an electric discharge voltage (eg) are compared during the time of the pulse width (Ton), the electric discharge voltage is determined to be lower than the short-circuit threshold voltage (Vsh). Here, because the applied voltage does not generate when short circuit occurs, the signal is recognized as small unloading electric discharge due to the unloading time being also short; therefore, when the signal is detected, it is necessary to subtract the short-circuit count (N1) from the small unloading electric-discharge count (N2).

FIG. 2(H) represents a one-shot signal generated in a case in which, when an abnormal electric-discharge threshold voltage (ng) is set in the machining-condition setting unit 11, and, for example, is compared to an applied voltage (V0), comparing to the signal in FIG. 2(D), the signal voltage is determined to be lower than the abnormal electric-discharge threshold voltage (Vng) during the unloading time.

In the electric-discharge detection circuit 13, by taking the signal represented in FIG. 2(C) using a counter, the signal is recognized as a total electric-discharge generation count (Nd); then, the short-circuit count (N1), the small unloading electric-discharge count (N2), and the abnormal electric-discharge count (N3) are obtained by taking the signal represented in FIG. 2(G), the signal that is obtained by subtracting the signal in FIG. 2(G) from the signal in FIG. 2(F), and the signal represented in FIG. 2(H), respectively, and by counting using a counter. Here, the normal electric-discharge count (Nn) is obtained by subtracting the short-circuit count (N1), the small unloading electric-discharge count (N2), and the abnormal electric-discharge count (N3) from the total electric-discharge generation count (Nd).

As described above, the conventional estimation has been performed by taking as voltage variation the state of the machining gap. However, in the present invention, by more quantitatively comprehending the phenomenon of each state, the electric-discharge state is recognized as more exact one; thus, control is to be performed by reflecting this result to the machining-axis feeding control. Specifically, regarding each state amount obtained from the electric-discharge detection circuit 13, the amount is transformed to an amount corresponding to the average voltage treated as above; then, the feeding of the machining axis is controlled based on the signal.

An idea according to the embodiment of the present invention is explained with respect to the control of the machining-axis feeding. First, as a fundamental concept, assuming that all of the total electric-discharge generation counts (Nd) obtained by the electric-discharge detection circuit 13 are based on the normal electric discharge, a case in which the feeding of the machining axis is controlled is explained. It is assumed that the electric-discharge generation count (Nd) during any one of sampling times (Ts) is N.

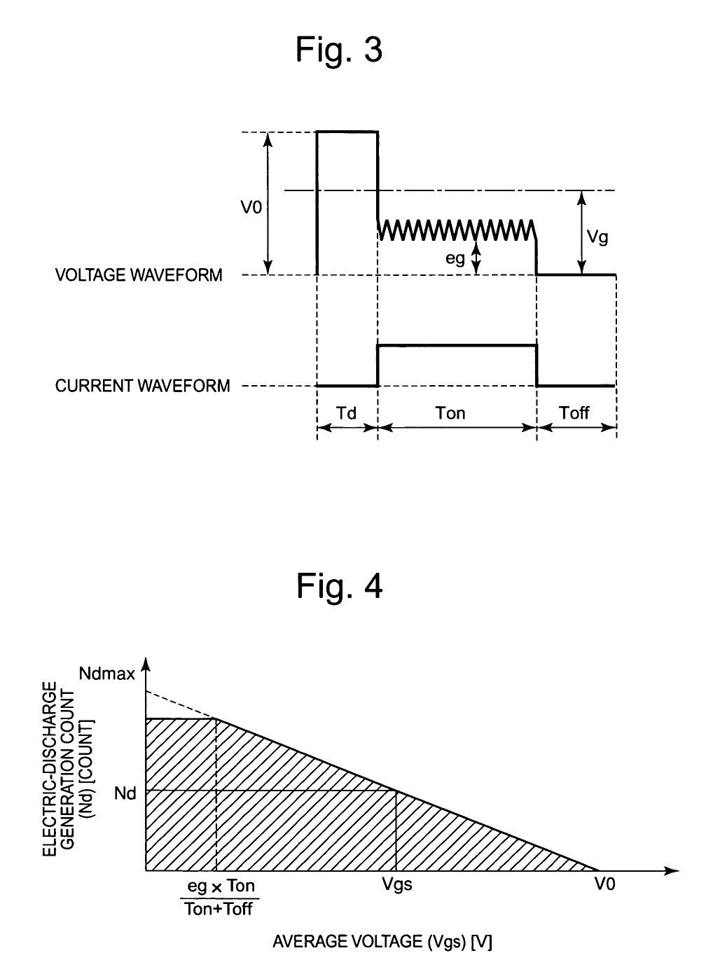

A single-electric-discharge time is composed of the unloading time (Td), the pulse width (Ton), and the rest time (Toff), where the pulse width (Ton) and the rest time (Toff) are values set by the machining-condition setting unit 11. The unloading time (Td) cannot be set, but is a variable value in response to the machining state. In the machining-axis feeding control based on the average voltage (Vg), the machining-axis feeding is controlled so as to keep the average voltage (Vg) across the machining gap at the servo standard voltage (SV), and, as represented in FIG. 3, the average voltage (Vg) of any single electric discharge can be expressed by:

$$Vg = \frac{V 0 \times Td + eg \times Ton}{Td + Ton + Toff} \qquad ( Eq . 1 )$$

Therefore, it is found that setting of the average voltage (Vg) to the servo standard voltage (SV) is the same as controlling of the unloading time (Td), which is an unknown value, to be constant, because all of the pulse widths (Ton), the rest times (Toff), and the applied voltages (V0) are known values set by the machining-condition setting unit 11, and because the electric-discharge voltage (eg) that is determined by combination or polarity of the tool electrode 8 and the target W is a value in the range of 20-30 V. Accordingly, assuming that the unloading time (Td) is invariable in an ideal case in which the machining state is controlled to be constant, the electric-discharge generation count (Nd) during any one of the sampling times (Ts) can be obtained, and the equation can be expressed by:

Ts=Σ(Td+Ton+Toff)=Nd×(Td+Ton+Toff) (Eq. 2)

That is, if the electric-discharge generation count (Nd) during any one of the sampling times (Ts) is found, the unloading time (Td) in this case is written by:

$$Td = \frac{Ts}{Nd} - Ton - Toff \qquad ( Eq . 3 )$$

Although an average voltage during any single-electric-discharge time is used in Eq. 1, the average voltage (Vg) during any one of the sampling times (Ts) may be considered to include an Nd-times aggregation of this single electric discharge; therefore, Eq. 1 can be expressed, using Eq. 3, by:

$$Vgs = V 0 - \frac{Nd}{Ts} \times \{ Ton \times ( V 0 - eg ) + Toff \times V 0 \} \qquad ( Eq . 4 )$$

Accordingly, the average voltage (Vg), as an electric-discharge-state amount, during the any one of the sampling times (Ts) can be obtained only by detecting the electric-discharge generation count (Nd) without detecting the machining-gap voltage. Therefore, by using this average voltage (Vgs), instead of the conventional average voltage (Vg) detected, for controlling the machining-axis feeding, machining-axis feeding control to which an exact state amount that is not affected by any electrical disturbance is reflected can be performed.

According to Eq. 4, the machining-gap average voltage is expressed by a first-order equation for the electric-discharge generation count (Nd). This represents that, when the average voltage (Vg) during the sampling time (Ts) is the same as the applied voltage (V0), the electric-discharge generation count (Nd) is nil, that is, electric discharge does not generate. Meanwhile, when the average voltage (Vg) during the sampling time (Ts) is nil, that is, when short-circuited, the electric-discharge generation count (Nd) can be expressed, from Eq. 4 or Eq. 3, by:

$$Nd = \frac{Ts}{Ton + Toff} \qquad ( Eq . 5 )$$

However, the electric-discharge generation count (Nd) expressed by Eq. 5 is not said to be the generative maximum electric-discharge generation count (Ndmax). The reason is because, actually, under the predetermined pulse width (Ton) and rest time (Toff), when the unloading time (Td) is nil, the maximum electric-discharge generation count is determined by repetition of only the pulse width (Ton) and the rest time (Toff). Therefore, assuming that the unloading time (Td) in Eq. 1 is nil, the average voltage is written by:

$${Vg}_{Td = 0} = \frac{eg \times Ton}{Ton + Toff} \qquad ( Eq . 6 )$$

Therefore, also regarding this average voltage (Vg), because the electric-discharge generation count becomes the maximum electric-discharge generation count (Ndmax), a proportional relationship in Eq. 4 is found in a voltage range from the applied voltage (V0) to the voltage in Eq. 6. Meanwhile, regarding the lower voltage, the generation count does not exceed the electric-discharge generation count (Nd) expressed by Eq. 5. That is, a relationship represented in FIG. 4 is obtained. That is, in a range of the average voltage (Vg) during any one of the sampling times (Ts) from nil to the voltage represented in Eq. 6, the electric-discharge generation count (Nd) becomes the same as the maximum electric-discharge generation count (Ndmax); therefore, when all of the total electric-discharge generation counts (Nd) are treated as the normal electric-discharge ones, it is limited by this region, where the exact average voltage (Vgs) can be calculated.

A problem of the system in the present invention is that, when all of the total electric-discharge generation counts (Nd) are treated as the normal electric-discharge ones, the exact average voltage (Vg) cannot be recognized in the range of the average voltage (Vg) during the any one of the sampling times (Ts) being from nil to the voltage represented in Eq. 6. However, in this range, because it can be found to be in a state in which a small unloading electric-discharge state whose unloading time (Td) is relatively short, a short-circuited state, or a state in which their mixed state is frequently occurs, these two states may be recognized and reflected. Therefore, because a state in which the unloading time (Td) is nil as found in Eq. 6 is in this region, actually recognition may be performed how often the short circuit has occurred.

Therefore, in the electric-discharge detection circuit 13, measurement is performed assuming as the short-circuit count (N1) the count of the electric-discharge pulses whose voltage is lower than the short-circuit threshold voltage (Vsh) determined by the machining-condition setting unit 11. If dependency of this short-circuit count (N1) on the total electric-discharge generation count (Nd) is found, Eq. 2 can be expressed by:

Ts=Σ(Td+Ton+Toff)=(Nd−N1)×(Td+Ton+Toff)+N1×(Ton+Toff) (Eq. 7)

Moreover, in a case in which the unloading time (Td) is not included when short-circuited, considering that the short-circuit voltage (Vsh) appears, Eq. 4 can be expressed, using Eq. 7, by:

$$Vgs = V 0 - \frac{Nd - N 1}{Ts} \{ Ton ( V 0 - eg ) + Toff \times V 0 \} - \frac{N 1}{Ts} \{ V 0 \times ( Ton + Toff ) \} \qquad ( Eq . 8 )$$

When the short circuit occurs, the short-circuit voltage is 0 V in almost every case. Therefore, assuming that the short-circuit threshold voltage (Vsh) is 0 V, Eq. 8 can be written by:

$$Vgs = V 0 - \frac{Nd - N 1}{Ts} \{ Ton ( V 0 - eg ) + Toff \times V 0 \} - \frac{N 1}{Ts} \{ V 0 \times ( Ton + Toff ) \} \qquad ( Eq . 9 )$$

Accordingly, when the average voltage (Vgs) during the any sampling time (Ts) is obtained, also in a case in which the short-circuit count (N1) is mixedly included in the total electric-discharge generation count (Nd), average-voltage conversion can be correctly performed.

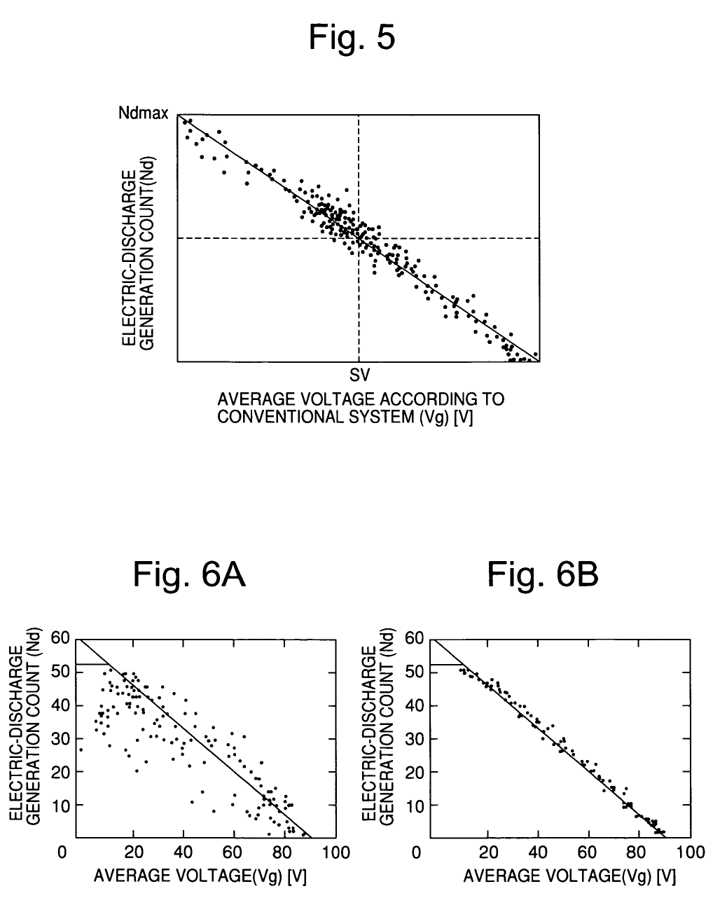

Using a cupper material of 10 mm diameter as the tool electrode 8, and a steel material as the target W, when machining is performed under a test condition represented in table 1 in which the machining-axis feeding is controlled by the conventional method, a relationship between the average voltage (Vg) across the machining gap and the total electric-discharge generation count (Nd) is represented in FIG. 5.

TABLE 1

| | No. 1 |
|---|---|
| Axis feeding system | Conventional |
| Tool electrode | 10 mm diameter, Cu |
| Target to be machined | Steel |
| IP (A) | 8 |
| Ton (μsec) | 64 |
| Toff (μsec) | 64 |
| VO (V) | 80 |
| SV (V) | 40 |
| JUNP | Not controlled |

In FIG. 5, the straight line represents a result in which Eq. 9 is applied to this graph. If the average voltage (Vgs) used for controlling the machining-axis feeding according to the present invention is reasonable, all of the total electric-discharge-generation counts (Nd) each plotted for the average voltage (Vg) for each sampling time (Ts) are to be mapped onto the straight line; as expected, from the test results, it was found that almost of the plotted points are fitted by the straight line. That is, the average voltage (Vgs) newly created in the present invention is found to be usable instead of the conventional average voltage (Vg) for controlling the machining-axis feeding.

When electric discharge other than the normal electric discharge is recognized, by providing the rest time (Toffs) that is set by extending the rest time (Toff), control for stabilizing a machining operation has been conventionally performed; therefore, next, compensation of Eq. 9 is explained in a case of the rest-time extension. Because of considering the short-circuit count (N1), the small unloading electric-discharge count (N2), and the abnormal electric-discharge count (N3) that are obtained by the electric-discharge detection circuit 13, comprehension of the electric-discharge state other than the normal electric-discharge state is possible. It is sufficient to find how many times the rest control for extending the rest time has been performed. That is, it is sufficient, by providing that the rest time of the rest control according to the short circuit is Toffs1, the rest time of the rest control according to the small unloading electric discharge is Toffs2, and the rest time of the rest control according to the abnormal electric discharge is Toffs3, to find how amounts the rest component during any sampling time (Ts) has contributed; thus Eq. 7 can be expressed by:

Ts=Σ(Td+Ton+Toff)=(Nd−N1)×(Td+Ton+Toff)+N1×(Ton+Toff)+N1×Toffs1+N2×Toffs2+N3×Toffs3 (Eq. 10)

Accordingly, Eq. 9 can be expressed by:

$$Vgs = V 0 - \frac{Nd - N 1}{Ts} \{ Ton ( V 0 - eg ) + Toff \times V 0 \} - \frac{N 1}{Ts} \{ V 0 ( Ton + Toff ) \} - \frac{1}{Ts} \{ V 0 ( N 1 \times Toffs 1 + N 2 \times Toffs 2 + N 3 \times Toffs 3 ) \} \qquad ( Eq . 11 )$$

In order to generalize the equation, assuming that a kind of modes for controlling the rest is n, and each of the rest times when the rest is controlled is Toffsn, the equation can be expressed by:

Ts=(Nd−N1)×(Td+Ton+Toff)+N1×(Ton+Toff)+Z(Nn×Toffsn) (Eq. 12)

Reflecting this equation, Eq. 9 can be expressed by:

$$Vgs = V 0 - \frac{Nd - N 1}{Ts} \{ Ton ( V 0 - eg ) + Toff \times V 0 \} - \frac{N 1}{Ts} \{ V 0 \times ( Ton + Toff ) \} - \frac{1}{Ts} \{ V 0 \times \sum ( Nn \times Toffsn ) \} \qquad ( Eq . 13 )$$

That is, it can be represented that this method can also be applied to a case in which rest control other than the control due to the short circuit, the small unloading electric discharge, or the abnormal electric discharge is performed.

Using a cupper material of 10 mm diameter as the tool electrode 8, and a steel material as the target W, when machining is performed under a test condition represented in table 2 in which the machining-axis feeding is controlled by the conventional method, relationships:

(a) between the average voltage (Vgs) recognized, using Eq. 8, by the control in which the abnormal electric discharge is recognized and the total electric-discharge generation count (Nd), and
(b) between the average voltage (Vgs) recognized, using Eq. 11, by the control in which the abnormal electric discharge is recognized and the total electric-discharge generation count (Nd), are represented in FIG. 6.

TABLE 2

| | No. 1 |
|---|---|
| Axis feeding system | Conventional |
| Tool electrode | 10mm diameter, Cu |
| Target to be machined | Steel |
| IP (A) | 8 |
| Ton (μsec) | 64 |
| Toff (μsec) | 32 |
| VO (V) | 80 |
| SV (V) | 20 |
| JUNP | Not controlled |

The straight lines in FIG. 6 represent Eq. 11 fitted to these graphs, and, if the average voltage (Vgs) used for the machining-axis feeding control according to the present invention is reasonable, all of electric-discharge-generation counts (Nd) each plotted for the average voltage (Vg) for each sampling time (Ts) are to be mapped onto the straight lines. In the machining results as represented in the figures, the reasonable average voltage (Vgs) is not recognized, due to the rest control, in the former machining operation. Moreover, also when the total electric-discharge generation count (Nd) is nil, the average voltage becomes 0 V. Essentially, when the total electric-discharge generation count (Nd) is nil, a state in which the applied voltage (V0) is applied across the machining gap is to anise, that is, an open state is to arise; however, a case different from that state may also occur. The short-circuit state and the open state significantly differ from each other; however, considering the rest control in Eq. 11, correct recognition of the average voltage is possible as the later machining operation.

As an example of the rest control, when the applied voltage (V0) as represented in FIG. 2 falls during the unloading time (Td), the electric-discharge detection circuit recognizes the state as the abnormal electric-discharge one, and then increases the number of the abnormal electric-discharge count (N3). Accompanying this operation, the electric power source 9 controls the rest, which controls so as to change the rest time (Toff) to the rest time (Toff3) for the abnormal electric discharge. Moreover, a case in which the rest control is performed in parallel in response to the short circuit or the small unloading electric discharge is also similar to the above case, and when such rest control is performed, as represented by Eq. 11, the exact average voltage (Vgs) is recognized considering the rest-time extension. Furthermore, the definition of the abnormal electric discharge is variable, and the detection means and the recognition method, etc. are different from those in each conventional electric-discharge machining apparatus. However, when the abnormal electric discharge is recognized, the rest control is performed in most cases as above described; therefore, also when the detection means or the recognition method is different from the above, if a means is used in which the rest control is performed after the abnormal electric discharge, correct recognition of the average voltage across the machining gap is possible also when the rest control is performed.

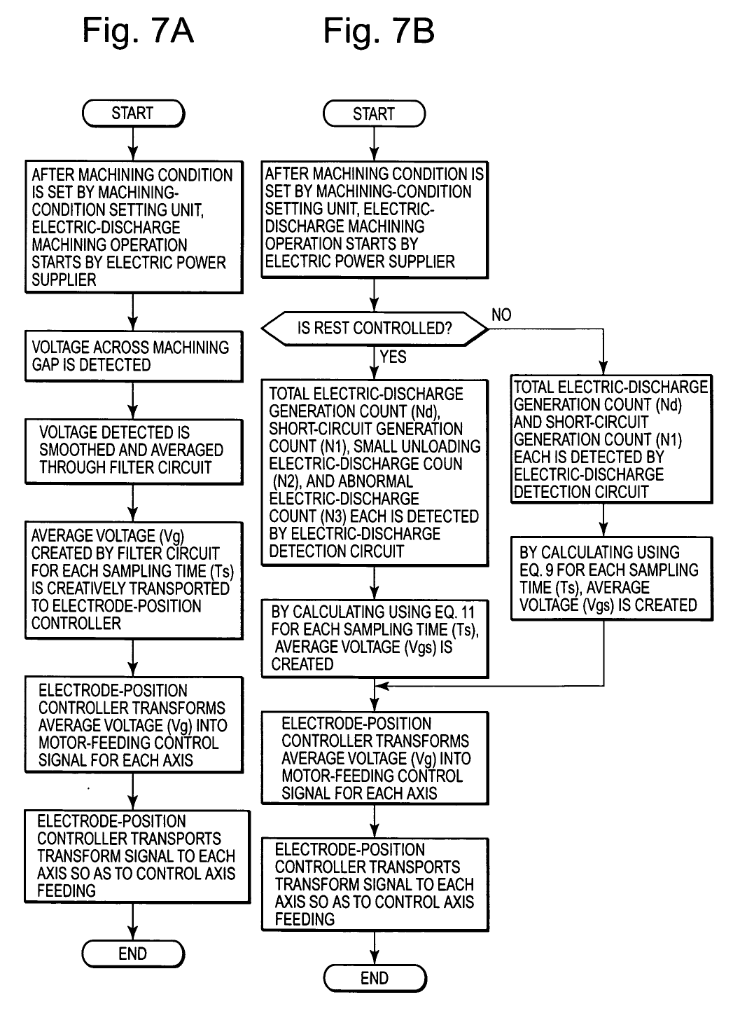

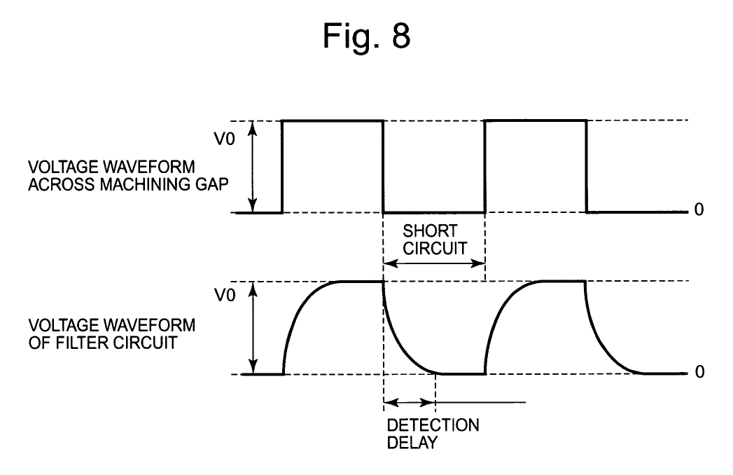

Next, a control flowchart according to Embodiment 1 of the present invention is represented in FIG. 7. A flowchart is represented in FIG. 7(a), in which the conventional machining-axis feeding control is performed by directly detecting the electric-discharge voltage across the machining gap, and by creating from the filter circuit the average voltage (Vg); meanwhile, a flow chart is represented in FIG. 7(b), in which the machining-axis feeding control according to the present invention is performed by creating from the electric-discharge generation count the average voltage (Vgs). The essential difference is not found between the control flows, that is, the difference is only in the signals, as the reference when the machining-axis feeding is controlled by the electrode position controller 10, whether the signal is created from the filter circuit (the conventional method: a), or created from the electric-discharge generation count recognized by the electric-discharge detection circuit 13 (the method of the present invention: b). As the control, the control flow is separated by whether machining where the rest is controlled is performed or not; that is, if the rest is controlled, the average voltage (Vgs) is calculated based on Eq. 11, meanwhile if the rest is not controlled, the average voltage (Vg) is obtained based on Eq. 9.

According to this embodiment, considering that a problem of the conventional technology is in the characteristics of the detection line or in the noise, by the method of the present invention, the average voltage is not directly detected, but the average voltage (Vgs) that is calculated from the total electric-discharge generation count (Nd) is used for the machining-axis feeding control. Therefore, not only the filter circuit as the problem of the conventional technology can be prevented, but also, by preventing the exclusive voltage detection line, harmful influence due to the noise component, etc. can be prevented; moreover, the machining-axis feeding control using the correct average voltage (Vg) can be realized. As a result, this technology significantly contributes to improve the machining face accuracy, etc. Moreover, when, for example, the average voltage (Vgs) decreases, considering the short-circuit generation count (N1), and subtracting the count from the total electric-discharge generation count (Nd), the average voltage across the machining gap can be correctly detected.

Here, in this embodiment according to the present, an example using a die-sinking electric-discharge machining apparatus is represented; however, if the machining-axis feeding is controlled using the average voltage (Vg) where the electric-discharge phenomenon is evaluated, although the feeding mechanism is different from the above, the control can be performed using the same concept as the above.

### Embodiment 2

Next, as Embodiment 2 of the present invention, setting of the small unloading time (Tdo) in an electric-discharge machining apparatus according to the present invention is explained, in which the machining-axis feeding is controlled.

The machining-condition setting unit 11 can set the small unloading time (Tdo) concerning that the small unloading electric discharge generating during the machining operation goes to the concentrated electric discharge, meanwhile, as explained in Embodiment 1, the electric-discharge detection circuit 13 compares this small unloading time (Tdo) with the unloading time (Td) for each electric-discharge machining operation.

Generally, because in a machining operation in which the small unloading electric discharge frequently occurs, the concentrated electric discharge is easy to occur, and is easy to go to arc, the unloading time (Td) is needed to be set to have a significant margin. On the other hand, because electric discharge does not occur during this unloading time (Td) itself, if the unloading time is too long, the machining efficiency decreases. Therefore, in order to increase the machining rate, by decreasing the servo standard voltage (SV) in addition to shortening the rest time (Toff), the unloading time (Td) is resultantly shortened. Accordingly, if the unloading time (Td) can be set short at a level in which the concentrated electric discharge does not occur, an ideal machining rate may be obtained.

Additionally, as one of elements needed for increasing the machining rate, an average current density (Id) during a machining operation is included. That is, the energy amount to be supplied to an area corresponding to the tool electrode 8 as a machining area is approximately determined by the combination of the tool electrode and the target W. It is known that, if the energy amount does not exceed this average current density (Id), stable machining operation is maintained in almost all cases. When a machining operation is performed, if, in addition to an area (S) of the tool electrode 8, the electric discharge current (IP), the pulse width (Ton), the rest time (Toff), the servo standard voltage (SV), and the applied voltage (V0) among the machining parameters set by the machining-condition setting unit 11 are found, using Eq. 1, the unloading time (Td) to be a target during a machining operation can be calculated; then, the average current density (Id) during the machining operation can be expressed by:

$$Id = IP \frac{Ton}{Td + Ton + Toff} / S \qquad ( Eq . 14 )$$

Using the equation, the supplied energy amount per unit area can be calculated.

When a machining operation in which the side of the tool electrode 8 is set to the positive electrode is performed using copper as the tool electrode 8 and steel material as the target W, although depending on the shape of the tool electrode 8, if the average current density (Id) does not exceed the range of 5-15 A/cm², the machining operation is known, from various experimental results, to be stabilized. When a machining operation in which the side of the tool electrode 8 is set to the positive electrode is performed using graphite as the tool electrode 8 and steel material as the target W, although depending on the shape of the tool electrode 8, if the average current density (Id) does not exceed the range of 2-5 A/cm², the machining operation is similarly known to be stabilized. Moreover, when a machining operation in which the side of the tool electrode 8 is set to the negative electrode is performed using copper-tungsten alloy as the tool electrode 8 and sintered hard alloy as the target W, although depending on the shape of the tool electrode 8, if the average current density (Id) does not exceed the range of 3-10 A/cm², the machining operation is similarly known to be stabilized.

When an area (S) of the target W to be machined, in addition to the fundamental machining-condition setting, is inputted in the machining-condition setting unit 11 of the present invention, if the set electric-discharge current (IP), pulse width (Ton), and the rest time (Toff) are determined, the unloading time (Td) as the target is determined by Eq. 14; thereby, by applying the result to Eq. 1, the servo standard voltage (SV) to be set for each machining condition is determined. Assuming that the unloading time (Td) calculated here is the limited unloading time (Tds), and that this value is taken as the small unloading time (Tdo), a dangerous state during the concentrated electric-discharge operation can be detected. In order to obtain the suitable small-unloading-time (Tdo), machining operations were performed under conditions listed in table 3.

TABLE 3

| | No. 1 | No. 2 | No. 3 | No. 4 | No. 5 | No. 6 | No. 7 |
|---|---|---|---|---|---|---|---|
| Tool | CuW | CuW | CuW | CuW | CuW | Cu | Cu |
| electrode | | | | | | | |
| Target | WC | WC | WC | WC | WC | St | St |
| IP (A) | 65 | 65 | 65 | 65 | 65 | 6 | 6 |
| Ton (μsec) | 20 | 20 | 20 | 20 | 20 | 0.8 | 0.8 |
| Toff (μsec) | 50 | 50 | 50 | 50 | 50 | 8.0 | 8.0 |
| VO (V) | 80 | 20 | 20 | 20 | 20 | 150 | 150 |
| SV (V) | 40 | 40 | 40 | 40 | 40 | 90 | 90 |
| Tds (μsec) | 60 | 60 | 60 | 60 | 60 | 60 | — |
| Tdo (μsec) | 0 | 60 | 10 | 20 | 20 | 0 | — |
| Rate (g/min) | 0.085 | 0.074 | 0.102 | 0.098 | 0.092 | 0.002 | 0.0002 |
| Depletion | 18.5 | 16.8 | 18.0 | 17.2 | 17.5 | 16.1 | 19.3 |
| (%) | | | | | | | |
| Face quality | Smeared | Fine | Slightly | Fine | Fine | Fine | Smeared |
| | | | smeared | | | | |
| Electrode | Corner | Fine | Fine | Fine | Fine | Fine | Fine |
| depletion | depleted | | | | | | |
| Axis-feeding | New | New | New | New | Conventional | New | Conventional |
| control | method | method | method | Method | method | method | method |

In a machining operation in which the side of the tool electrode 8 is set to the negative electrode using a 10 mm square copper-tungsten-alloy plate as the tool electrode 8 and sintered hard alloy as the target W, when the machining operation is performed under a condition in which the rough machining condition is listed in table 2 (No. 1), if the average current density (Id) is set at 10 A/cm², the servo standard voltage is 40 V, and the limited unloading time (Tds) is 60 μsec. In this test, although neither the small unloading time (tdo) was set, nor the rest control was performed even if electric discharge within the unloading time (Td) that is shorter than the limited unloading time (Tds) generates, the electric discharge did not go to a large arc; however, any black smear remained on the machined face, and significantly depleted portions were locally found at the corner of the electrode. Therefore, in order to observe the varying of the machining state with the small unloading time (Tdo) varying, by setting the small unloading time (Tdo) at 60 μsec (No. 2) that is the same as the limited unloading time (Tds), 10 μsec (No. 3), and 20 μsec (No. 4), when the small unloading time (Tdo) continuously generated twice, the test was performed under the rest control in which one more rest time (Toff) is given. As represented in table 2, under the condition of No. 2, although problems of the machined face or the electrode depletion did not occur, the machining time was lengthened by ten or more than ten percent, meanwhile under the condition of No. 4, not only problems of the machined face or the electrode depletion did not occur, but also the machining rate could be increased. If a value of approximately 0-1.0 times the limited unloading time (Tds), preferably approximately 0.3-0.5 times the limited unloading time (Tds), is set as the small unloading time (Tdo), a satisfactory machining procedure is considered to be able to realize from this result. That is, also when an electric-discharge operation whose time is equivalent to the limited unloading time (Tds) continues, the energy does not exceed the limitation of the current density in this state; therefore, if the rest control is performed in response to the electric discharge operation within the unloading time (Td) of this state, the machining rate oppositely decreases. If the small unloading electric discharge is considered to go to the concentrated electric discharge due to continuing of the small unloading electric discharge, it is considered that the continuing of the electric discharge within the unloading time (Td) that is shorter than the limited unloading time (Tds) leads to danger. Therefore, it is considered in this experiment that a preferable result was obtained at approximately ⅓ times the limited unloading time (Tds). Here, although the machining-axis feeding control according to the present invention was performed in this experiment, when, with respect to the test of No. 4 in which the result of the machining operation was preferable, a machining operation was performed by the conventional machining-axis feeding control (No. 5), a result close to the similar result of No. 4 could be obtained; however, the result of the machining-axis feeding control according to the present invention was more preferable than the other. It can be considered that the reason is because the average voltage during the machining operation was correctly recognized, and the recognized result could be reflected to the machining-axis feeding control.

Similarly, in a machining operation in which the side of the tool electrode 8 is set to the negative electrode using a 10 mm square copper plate as the tool electrode 8 and iron-steel material as the target W, when the machining operation is performed under a condition in which the finishing-machining condition is listed in table 2 (No. 1), if the average current density (Id) is set at 10 A/cm², the limited unloading time (Tds) goes negative; thereby, it is found that, if the energy exceeds the current density, abnormality does not generate in the machining operation. Therefore, the rest control was not performed during the small unloading electric discharge operation. In a case of such small machining energy, apprehension of short circuit due to the small machining gap is most serious; therefore, the experimental was performed in which, by setting as the servo standard voltage (SV) a value that is any higher than ½ of the applied voltage (V0), any margin is given to the machining gap, and the rest control is performed when once a short circuit occurs.

In the machining-axis feeding control according to the present invention, a favorite result could also be obtained in the finishing-machining process. In the conventional method (No. 7), the short circuit during the machining operation occurred a little more frequently; as a result, increase of the depletion as well as generation of any smear on the machined face was observed. In the conventional system, because the average voltage (Vg) using the filter circuit is used, the time delay based on the time constant of the filter circuit generates until the voltage falls to 0 V after a sudden short circuit has occurred; thereby, the above result can be considered to be caused by another time delay to recognize the voltage varying having occurred. Meanwhile, in the new system, because the operation is independent from the time constant of the filter circuit, the recognition is immediately performed after the short circuit has occurred; thereby, the above result can be considered to be caused by the recognition having been reflected to the machining-axis feeding control. It was found that when the limited unloading time (Tds) is not longer than nil, the rest control may not necessarily be performed during the small unloading electric-discharge operation. In a case in which the area (S) is narrowed, or the limited unloading time (Tds) is lengthened due to increase of the electric-discharge current (IP) or the pulse width (Ton), similarly to the rough machining operation, the small unloading time (Tdo) of 0.3-0.5 times the limited unloading time (Tds) may be set.

### Embodiment 3

Based on the rest-control method during the abnormal electric-discharge operation, oppositely by continuing the normal electric discharge, the rest time (Toff) can also be shortened when the energy does not exceed the current density (Id). For example, in a case in which a recognition signal is generated for timing when the normal electric discharge occurs continuously five times, and the rest time is shortened at that time, by giving that the count occurred continuously five times is a rest shortening count (N4), and by presetting the rest time as a shortening rest time (Toff4), the rest shortening count (N4) is detected by the electric-discharge detection circuit 13 for each any every sampling time (Ts), and then the average voltage (Vgs) is calculated using Eq. 13. Thereby, this system can also be applied to a case in which not only control of the short circuit, the small unloading electric discharge, and the abnormal electric discharge, but also control for shortening the rest time in a stable state is performed.

As described above, by applying the average voltage system using the average voltage (Vgs) for calculating the machining-axis feeding control using the total electric-discharge generation count (Nd), the control equivalent to the conventional one was ascertained to be possible. Moreover, by using the electric-discharge counter, it has become possible not only to prevent the filter circuit that causes a problem in the conventional technology, but also to prevent the exclusive voltage detection line so as to prevent harmful influence due to any noise component, etc.

In a case, for example, in which the average voltage (Vgs) decreases, it was found that, considering the short-circuit generation count (N1), and using a system in which the short-circuit generation count (N1) is subtracted from the total electric-discharge generation count (Nd), the average voltage across the machining gap can be correctly detected.

Moreover, in the machining-axis feeding control, by setting as the small unloading time (Tdo) a time to a range of 0-1.0 times, preferably the time to a range of 0.3-0.5 times, the limited unloading time (Tds) calculated from the current density (Id), and by controlling the rest, a preferable machining result can be obtained.

Furthermore, also in a case in which the rest is controlled by recognizing electric discharge other than the normal electric discharge, not only a machining operation is performed with the correct average voltage being calculated, but also, when control is also performed to shorten the rest in a stable state, a machining operation can be performed with the correct average voltage being calculated.

1-13. (canceled)

14. An electric-discharge machining apparatus for controlling a machining axis so that a machining average voltage Vg during a predetermined sampling time Ts agrees with a servo standard voltage SV, the apparatus comprising:
an electric power supplier for supplying electric power between electrodes of a tool electrode and a target to be machined;
an electric-discharge detection circuit for detecting the waveform of electric discharge generating between the electrodes based on the electric power supplied by the electric power supplier;
an electric-discharge generation counter for counting in response to the waveform an electric-discharge generation count Nd during the predetermined sampling time Ts;
a calculator for calculating an estimation average voltage Vgs between the electrodes, based on:
$$Vgs = V 0 - \frac{Nd}{Ts} \times \{ Ton \times ( V 0 - eg ) + Toff \times V 0 \}$$
where Nd is the electric-discharge generation count, V0 is a predetermined applied voltage, Ton is a pulse width, Toff is a rest time, eg is an electric-discharge voltage, and Ts is the sampling time; and
an electrode-position controller for controlling the machining axis so that the estimation average voltage Vgs calculated by the calculator agrees with the servo standard voltage SV during the sampling time Ts.

15. An electric-discharge machining apparatus as recited in claim 14, further comprising:
in addition to the electric-discharge generation counter, a short-circuit generation counter for counting a short-circuit count N1 of short-circuit electric discharge in which the voltage of electric discharge accompanied by the applied voltage supplied by the electric power supplier is lower than a predetermined short-circuit threshold voltage Vsh, wherein calculation of the estimation average voltage Vgs by the calculator is compensated.

16. An electric-discharge machining apparatus as recited in claim 15, wherein the estimation average voltage Vgs is calculated by:
$$Vgs = V 0 - \frac{Nd - N 1}{Ts} \{ Ton ( V 0 - eg ) + Toff \times V 0 \} - \frac{N 1}{Ts} \{ V 0 \times ( Ton + Toff ) \}$$

17. An electric-discharge machining apparatus for controlling a machining axis so that a machining average voltage Vg during a predetermined sampling time Ts agrees with a servo standard voltage SV, the apparatus comprising:
an electric power supplier for supplying electric power between electrodes of a tool electrode and a target to be machined;
an electric-discharge detection circuit for detecting the waveform of electric discharge generating between the electrodes based on the electric power supplied by the electric power supplier;
an electric-discharge generation counter for counting in response to the waveform an electric-discharge generation count Nd during the predetermined sampling time Ts;
a short-circuit generation counter for counting a short-circuit count N1 of short-circuit electric discharge in which the voltage of electric discharge accompanied by the applied voltage supplied by the electric power supplier is lower than a predetermined short-circuit threshold voltage Vsh;
a small unloading electric-discharge counter for counting a small unloading electric-discharge count N2 of electric discharge to which the applied voltage supplied by the electric power supplier changes within a predetermined small unloading time Tdo;
a calculator for calculating an estimation average voltage Vgs between the electrodes, based on the electric-discharge generation count Nd, the short-circuit count N1, the small unloading electric-discharge count N2, and the abnormal electric-discharge count N3; and
an electrode-position controller for controlling the machining axis so that the estimation average voltage Vgs calculated by the calculator agrees with the servo standard voltage SV during the sampling time Ts.

18. An electric-discharge machining apparatus as recited in claim 17, wherein the estimation average voltage Vgs is calculated considering rest-time extension based on the electric-discharge generation other than normal electric-discharge generation.

19. An electric-discharge machining apparatus as recited in claim 18, wherein the estimation average voltage Vgs is calculated by:
$$Vgs = V 0 - \frac{Nd - N 1}{Ts} \{ Ton ( V 0 - eg ) + Toff \times V 0 \} - \frac{N 1}{Ts} \{ V 0 ( Ton + Toff ) \} - \frac{1}{Ts} \{ V 0 ( N 1 \times Toffs 1 + N 2 \times Toffs 2 + N 3 \times Toffs 3 ) \}$$
where Toffs1 is a rest time according to the short circuit, Toffs2 is a rest time according to the small unloading electric discharge, and Toffs3 is a rest time according to the abnormal electric discharge.

20. An electric-discharge machining apparatus for controlling a machining axis so that a machining average voltage Vg during a predetermined sampling time Ts agrees with a servo standard voltage SV, the apparatus comprising:
an electric power supplier for supplying electric power between electrodes of a tool electrode and a target to be machined;
an electric-discharge detection circuit for detecting the waveform of electric discharge generating between the electrodes based on the electric power supplied by the electric power supplier;
an electric-discharge generation counter for counting in response to the waveform an electric-discharge generation count Nd during the predetermined sampling time Ts;
a small unloading electric-discharge counter for counting a small unloading electric-discharge count N2 of electric discharge to which electric discharge accompanied by the applied voltage supplied by the electric power supplier changes within a predetermined small unloading time Tdo;
a calculator for calculating an estimation average voltage Vgs between the electrodes, based on the electric-discharge generation count Nd, and the small unloading electric-discharge count N2; and
an electrode-position controller for controlling the machining axis so that the estimation average voltage Vgs calculated by the calculator agrees with the servo standard voltage SV during the sampling time Ts.

21. An electric-discharge machining apparatus as recited in claim 20, wherein the small unloading time Tdo is set to 0.3-0.5 times a limited unloading time Tds calculated based on the average current density Id of the electric discharge.

22. An electric-discharge machining method of controlling a machining axis so that a machining average voltage Vg during a predetermined sampling time Ts agrees with a servo standard voltage SV, the method comprising:
a step of detecting the waveform of electric discharge generating, based on supplied electric power, between electrodes of a tool electrode and a target to be machined;
a step of counting in response to the waveform an electric-discharge generation count Nd during the predetermined sampling time Ts;
a step of calculating an estimation average voltage Vgs between the electrodes, based on the electric-discharge generation count Nd, and based on:
$$Vgs = V 0 - \frac{Nd}{Ts} \times \{ Ton \times ( V 0 - eg ) + Toff \times V 0 \}$$
where V0 is a predetermined applied voltage, Ton is a pulse width, Toff is a rest time, eg is an electric-discharge voltage, and Ts is the sampling time; and
a step of controlling the machining axis so that the estimation average voltage Vgs calculated agrees with the servo standard voltage SV within the sampling time Ts.

23. An electric-discharge machining method as recited in claim 22, wherein the estimation average voltage Vgs is obtained by counting a short-circuit count N1 of short-circuit electric discharge in which the voltage of electric discharge accompanied by the applied voltage supplied by an electric power supplier is lower than a predetermined short-circuit threshold voltage Vsh, and by compensating using:
$$Vgs = V 0 - \frac{Nd - N 1}{Ts} \{ Ton ( V 0 - eg ) + Toff \times V 0 \} - \frac{N 1}{Ts} \{ V 0 \times ( Ton + Toff ) \}$$

24. An electric-discharge machining method as recited in claim 22, wherein the estimation average voltage Vgs is obtained by counting a short-circuit count N1 of short-circuit electric discharge in which the voltage of electric discharge accompanied by the applied voltage supplied by an electric power supplier is lower than a predetermined short-circuit threshold voltage Vsh, a small unloading electric-discharge count N2 of electric discharge to which the applied voltage supplied by the electric power supplier changes within a predetermined small unloading time Tdo, and an abnormal electric-discharge count N3 of abnormal electric discharge whose voltage reaches a lower value than a predetermined abnormal electric-discharge threshold voltage Vng, and by using:
$$Vgs = V 0 - \frac{Nd - N 1}{Ts} \{ Ton ( V 0 - eg ) + Toff \times V 0 \} - \frac{N 1}{Ts} \{ V 0 ( Ton + Toff ) \} - \frac{1}{Ts} \{ V 0 ( N 1 \times Toffs 1 + N 2 \times Toffs 2 + N 3 \times Toffs 3 ) \}$$
where Toffs1 is a rest time according to the short circuit, Toffs2 is a rest time according to the small unloading electric discharge, and Toffs3 is a rest time according to the abnormal electric discharge.

25. An electric-discharge machining method of controlling a machining axis so that a machining average voltage Vg during a predetermined sampling time Ts agrees with a servo standard voltage SV, the method comprising:
a step of detecting the waveform of electric discharge generating, based on supplied electric power, between electrodes of a tool electrode and a target to be machined;
a step of counting in response to the waveform an electric-discharge generation count Nd during the predetermined sampling time Ts;
a step of counting a small unloading electric-discharge count N2 of electric discharge to which electric discharge accompanied by the applied voltage supplied by an electric power supplier changes within a predetermined small unloading time Tdo,
a step of calculating an estimation average voltage Vgs between the electrodes, based on the electric-discharge counts Nd, and N2; and
a step of controlling the machining axis so that the estimation average voltage Vgs calculated agrees with the servo standard voltage SV during the sampling time Ts.
